(19) United States
(12) Patent Application Publication
(10) Pub. No.: US 2021/0327003 A1
(43) Pub. Date: Oct. 21, 2021

(54) System and Method for Discovering Individuals in Close Proximity

(71) Applicant: Gregory Caruso, Santa Monica, CA (US)

(72) Inventor: Gregory Caruso, Santa Monica, CA (US)

(21) Appl. No.: 16/852,970

(22) Filed: Apr. 20, 2020

(51) Int. Cl. G06Q 50/00; H04W 4/02; H04W 4/024; H04W 4/021; H04W 4/12; H04W 4/21

(52) U.S. Cl. CPC G06Q 50/01; H04W 4/023; H04W 4/21; H04W 4/021; H04W 4/12; H04W 4/024

(57) ABSTRACT

A system and method is provided for facilitating a communication between at least a first and second user device, where the first and second users have accounts with the host and are currently in close proximity to one another, thereby providing an easy, nonintrusive method for expressing interest in and (at least initially) communicating with one another. The system preferably includes a host device in communication with a plurality of user devices via the Internet. In preferred embodiments, a map is presented to a user showing an individual's location with respect to the user. The user can then request to see the individual's profile and send a communication. The individual would then be notified and allowed to request the user's profile and respond accordingly. If there is a mutual interest, the individuals can then meet immediately, given their close proximity to one another.

### BACKGROUND OF THE INVENTION

### 1. Field of the Invention

The present invention relates to discovering individuals in close proximity to one another, or more particularly, to a system and method for using a network-connected host device to facilitate a communication between at least a first user and a second user, wherein the first and second users (a) have accounts with the host and (b) are currently in close proximity to one another, thereby providing an easy, nonintrusive method for expressing interest in and (at least initially) communicating with one another.

### 2. Description of Related Art

There are many dating applications and/or websites on the market, all of which have one primary goal—allowing an individual to meet a potential companion. This is traditionally done by allowing individuals to create accounts, where each account includes biographical information (e.g., age, sex, etc.) including at least one picture (see, e.g., FIG. 1A). A first individual would then be able to select searching criteria (see, e.g., FIG. 1B), and be presented with information (e.g., biographical information, pictures, etc.) on other individuals that meet the same. The first individual would then be allowed to select an individual of interest (e.g., a potential companion) and communicate with them via a provided forum (e.g., direct message, etc.). If the selected individual is interested, the two may arrange for an in-person meeting where further communications can take place outside of the provided forum.

The foregoing is an alternative to traditional dating methods, where the first individual would see the second individual (e.g., at a restaurant, etc.), approach the second individual, and express interest (e.g., by asking them for their number, if they could buy them a drink, etc.) (see, e.g., FIG. 2). While traditional dating methods are stressful (e.g., fear of getting rejected, etc.), there are times when such methods are not viable. For example, a girl may be sitting with a guy, and without knowing their relationship (e.g., are they dating, friends, related), approaching her may seem awkward if not downright disrespectful. By way of another example, the girl may be sitting with a group of girls and approaching her in the company of others would require courage that is beyond most men.

It is perhaps for this reason that most individuals turn to dating apps and/or websites. But these too are problematic. First, the experience is removed from reality. According to the Association for Psychological Science, reviewing multiple candidates causes people to be more judgmental and inclined to dismiss a not-quite-perfect candidate than they otherwise would be in a face-to-face meeting.

Second, they are rarely successful. One-third of people who use online dating sites have never actually gone on a date with someone that they met online. And for those that did, their relationships were 28% more likely to fail within the first year. And according to research conducted at Michigan State University, those that did end up getting married, were three times as likely to get divorced as couples that met face-to-face.

One reason for this is because people tend to lie (or exaggerate) on their online dating profiles. For example, in research conducted by a global research agency OpinionMatters, 53% of online daters admitted to lying on their dating profile. Women apparently lied more than men, with the most common dishonesties being about looks. For example, over 20% of women posted photos of their younger selves.

Thus, it would appear to be beneficial (e.g., more successful) if the online paradigm was reversed—where initial interest is the result of an in-person experience and the dating app and/or website is merely used to learn more about the individual (e.g., age, interests, etc.) and facilitate (at least initial) communications. That way an individual can react to their “first impression” (e.g., seeing someone that is visually appealing, making eye contact, etc.) and express interest without having to confront the person face-to-face. Such a system would allow an individual to express an interest in another without having to approach them in-person—or at least not before determining where the other individual is interested, or open to (or at least not opposed to) further communications.

### SUMMARY OF THE INVENTION

The present invention provides a system and method for using a network-connected host device to facilitate communications between at least a first user and a second user, where the first and second users (a) have accounts with the host (i.e., are members) and (b) are currently in close proximity to one another, thereby providing an easy nonintrusive method for expressing interest in and (at least initially) communicating with one another.

In preferred embodiments of the present invention, a host device is in communication with at least two user devices, e.g., a first user device and a second user device, via a wide area network, such as the Internet. The host device may include a web server for communicating with the user devices, a database for storing information, and at least one application for facilitating communications between the user devices.

In one embodiment of the present invention, a user may begin by setting up an account with the system (or host). The user may then login (e.g., using traditional techniques) and create a profile, which may include at least one photo, a username, date of birth, sex, and an autobiography (e.g., a brief description of the user). Other information (e.g., sexual preference, age group of interest, income level, educational level, etc.) may also be provided. This information may then be made available to other users (e.g., to determine whether there is interest, etc.). This information may also be used to limit the types of individuals that are shown to the user (e.g., single females, educated, wealthy, etc.).

The user may then be presented with a map of their surroundings, showing their location and the location of at least one other individual. For example, the map may show individuals that are within one square mile from the user, a certain radius from the user, within the same building as the user, etc. If the user moves (i.e., their location changes), then the map should preferably move with them. The user should also be able to alter the map (e.g., by dragging, pinching, or spreading their fingers, using navigation icons, a keyboard, mouse, etc.) to move in a particular direction (e.g., east, west, north, south), zoom in or zoom out.

If the user continues to zoom in, or interacts with (e.g., clicks on) a business, the user may be presented with information concerning individuals inside the business. For example, the map may show that an individual (who is a member) is sitting at the other end of the bar. Alternatively, the user may see an individual at the bar and open the application to see if the individual has an account or is a member. If they are, the user can then use the application to learn more about and communicate with the individual.

For example, by clicking on the individual within the map, the user may be presented with the individual's profile, including, for example, their autobiography (e.g., interests, etc.) and at least one image of the individual (e.g., allowing them to confirm that they have the correct profile, etc.). The user may also be allowed to send a communication to the individual. This communication may be a predefined communication, e.g., stating that they are “interested,” etc., or it may be a personal communication entered by the user. For example, the user may enter (e.g., by typing, etc.) “Can I buy you a drink?” The communication can then be sent to the individual, preferably via the host device.

The individual would then be notified and allowed to view the user's profile. The individual may then be allowed to express interest (e.g., click on “thumbs up”), block the user (e.g., which would block additional communications and may prevent them from being shown on a map presented to the individual), or reply. If the individual decides to reply, the individual may be presented with a text box and a send button, allowing them to enter a responsive message. The user may then see the back-and-forth communication—message, reply—and decide how to proceed. The user may then reply or decide to approach the individual (e.g., buy them that drink).

As can be seen, the present invention has provided a forum for individuals to meet, vet each other, and see if there is interest. If there is, the individuals can meet immediately (given the proximity). If there is not, the user can move on without having to deal with an uncomfortable rejection (e.g., in front of others), embarrassment, etc.

Clearly, for the present invention to function properly, location information of each user device must be shared with the host device. This location information can be acquire using one (or a combination of) known techniques, including, but not limited to use of global positioning satellites (“GPS”), assisted GPS, synthetic GPS, cellular towers (e.g., triangulation, signal strength, etc.), WiFi (e.g., triangulation, signal strength), Bluetooth beacons, etc. The present invention also needs location information on cities, streets, businesses, etc. This may be accomplished by using an application program interface (“API”) for a map product (or platform), such as Google Maps™.

A problem that is solved by the present invention is referred to as the “creep” factor, i.e., use of the system to stalk, harass, or annoy a user. The system solves this problem by allowing users to control their discoverability. For example, a user may decide to disable, or turn off, the discoverable feature, which would prevent others from learning their current location. Alternatively, the user could decide to limit their discoverability. This may result in the user knowing the general location of the individual (e.g., in a state, city, business, etc.), but not knowing their exact location. It may also prevent certain information from being shown to the user (e.g., photos, etc.).

It may also limit which users have access to an individual's location. For example, if a user is within a business, the user may see the location of individuals that are also within that business. However, if the user is outside the business (e.g., across the street, in a different city, etc.), the user may not be aware of individuals that are within the business (assuming their discoverability is limited, which is either a user setting or system configuration). It should be appreciated that the distance of discoverability (when limited) may also be a user setting or system configuration (i.e., predefined). This can be a very powerful tool, as it prevents unwanted stalking, as only those that actual see the individual (e.g., are sitting at the same bar, etc.), or are in close proximity (e.g., in the parking lot), are provided with location information. This would prevent remote user's from knowing the individual's location, and still allow a user within a pre-determined distance from the individual (e.g., sitting across the bar, etc.) to view the individual's profile and communicate with them prior to approaching them.

A more complete understanding of a system and method for using a network-connected host device to facilitate communications between at least first and second users will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIGS. 1A and B are examples of dating applications that are currently available, which include several drawbacks;

FIG. 2 illustrates an exemplary social environment in which the present invention is intended to operate;

FIG. 3 illustrates an environment in which the present invention is intended to operate, including first and second user devices in communication with a host device over a wide area network, such as the Internet;

FIG. 4 illustrates a user profile, or the creation thereof, in accordance with one embodiment of the present invention;

FIGS. 5A-6, 11-16, and 18-21, illustrate different maps (or screen shots) in accordance with one embodiment of the present invention, where at least first and second users are shown, including their relationship to one another;

FIGS. 7 and 10 illustrate a profile of, and a method of communicating with, a potential companion in accordance with one embodiment of the present invention;

FIGS. 8 and 9 illustrate an exemplary method of presenting communications to a potential companion in accordance with certain embodiments of the present invention;

FIG. 17 illustrates a user profile, or the creation thereof, in accordance with another embodiment of the present invention

FIGS. 22A and B illustrate alternate embodiments of the present invention;

FIG. 23 illustrates a method for enabling, disabling, or limiting one's discoverability to other users in accordance with one embodiment of the present invention; and

FIG. 24 illustrates a method for determining individuals that within a particular building or a predefined distance from said user in accordance with one embodiment of the present invention.

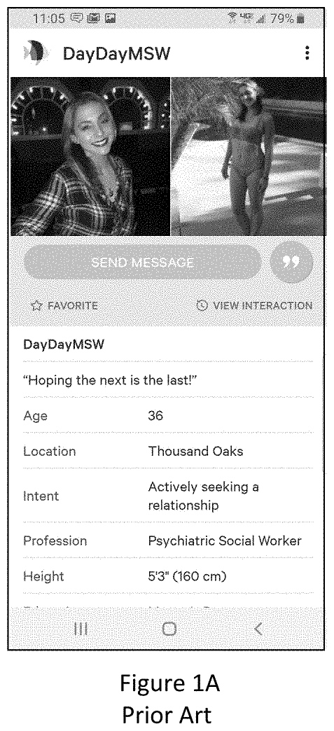

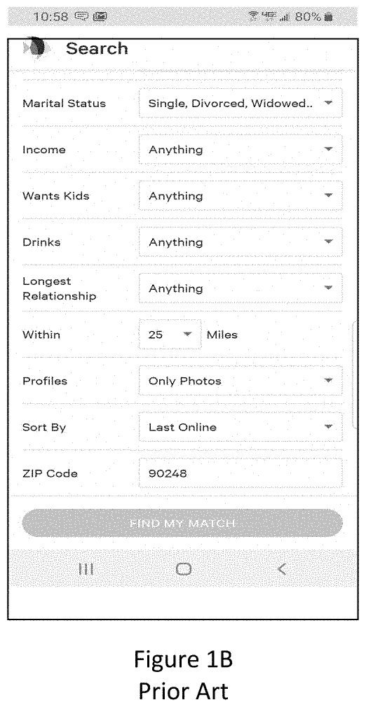

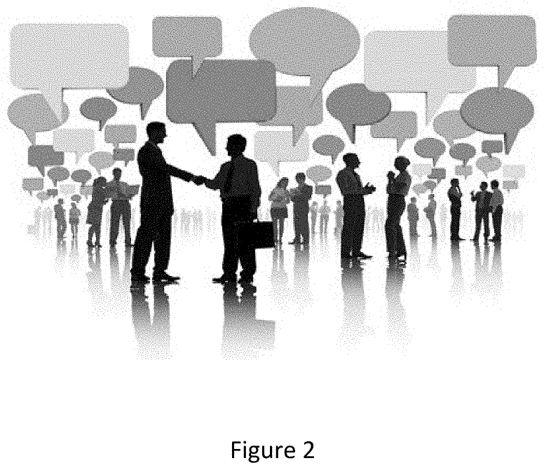

### DETAILED DESCRIPTION OF THE PREFERRED EMBODIMENT

The present invention provides a system and method for using a network-connected host device to facilitate a communication between at least a first user and a second user, wherein the first and second users (a) have accounts with the host (i.e., are members) and (b) are currently in close proximity to one another, thereby providing an easy, nonintrusive method for expressing interest in and (at least initially) communicating with one another. It should be appreciated that while the present invention is described in terms of a dating application, the present invention is not so limited. For example, the present invention could be used to identify and communicate with individuals, regardless of the topic of interest (e.g., to find a dinner companion, a fifth for basketball, a fourth for bridge, rideshare to the airport, etc.). It should also be appreciated that the term “application” is used broadly to encompass any type of code that is used to perform or carry out a series of tasks. Thus, the term “application” should be understood to include mobile apps, desktop apps, software, websites, etc., or any combination thereof.

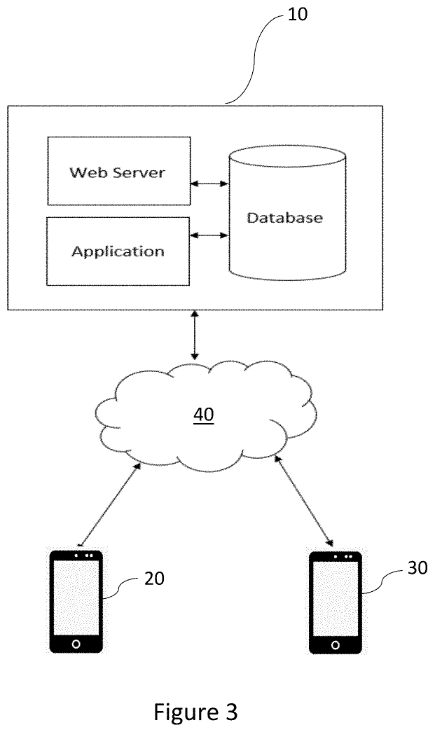

In preferred embodiments of the present invention, as shown in FIG. 3, a host device 10 is in communication with at least two user devices—a first user device 20 and a second user device 30—via a wide area network 40, such as the Internet. The host device may include a web server for communicating with the user devices, a database for storing information (e.g., account information, profile information, message information, etc.), and at least one application for facilitating communications between the user devices.

It should be appreciated that the present invention is not limited to the components illustrated in FIG. 3, and additional, fewer, and/or different components (and/or functionalities thereof) are within the spirit and scope of the present invention.

For example, the application may further be configured to receive location information from each user device, information from a mapping platform (e.g., via an API), and profile information, including personalized settings thereof, and provide maps to individual users identifying individuals that may be of interest to, and are in close proximity to, the user. It should further be appreciated that application may exist as a single application or a plurality of applications (locally and/or remotely stored) that operate together to perform the functionalities described herein.

In a preferred embodiment, the host device should be configured to communicate with a large number of user devices (e.g., thousands, tens of thousands, etc.). And those devices can be any type of user device, including, a smartphone, smartwatch, tablet, laptop, desktop, or any other network-enabled device generally known to those skilled in the art. It should also be appreciated that aspects of the present invention may be accomplished without the need for a host device. For example, the applications operating on the user devices may be configured to communicate directly with one another (e.g., via cellular telephone technology, etc.), without requiring a host to facilitate the same. With that being said, certain advantages of the present invention can be achieved using a host device (e.g., blocking communications, limiting discoverability, etc.), which will be discussed in greater detail below.

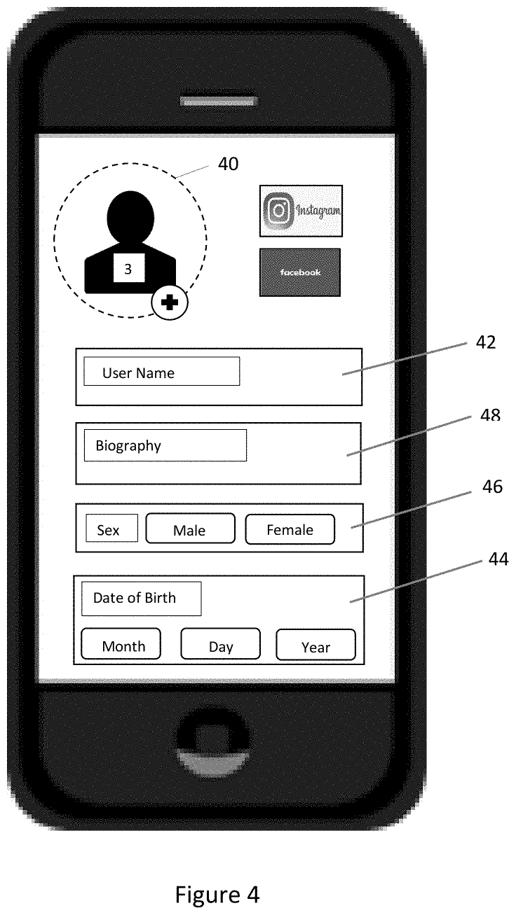

Discussion will now made with respect to exemplary screen shots. It should be appreciated that these screen shots are just that, exemplary, and are not limitations of the present invention. They are merely examples of how the present invention may operated in accordance with certain embodiments of the present invention. With that being said, FIG. 4 illustrates how a user may setup an account with the system. The user may first login using traditional techniques (e.g., name, password, biometrics, etc.) (not shown) and then create a profile, which may include at least one photo 40, which may be entered or acquired from a related social media account (e.g., Instagram™, Facebook™, etc.), a username 42, date of birth 44, sex 46, and an autobiography 48 (e.g., a brief description of the user).

It should be appreciated that other information may be provided, such as sexual preference, age group of interest, income level, educational level, etc. This information may be made available to other users who are viewing your profile (e.g., to determine whether there is interest, etc.). This information may also be used to limit the types of individuals that are shown to the user. For example, if a user is male, heterosexual, and twenty years old, then the system may be configured to present the user with information on females that within the ages of 18-26, and have other characteristics that may be of interest to the user (e.g., education, income, etc.).

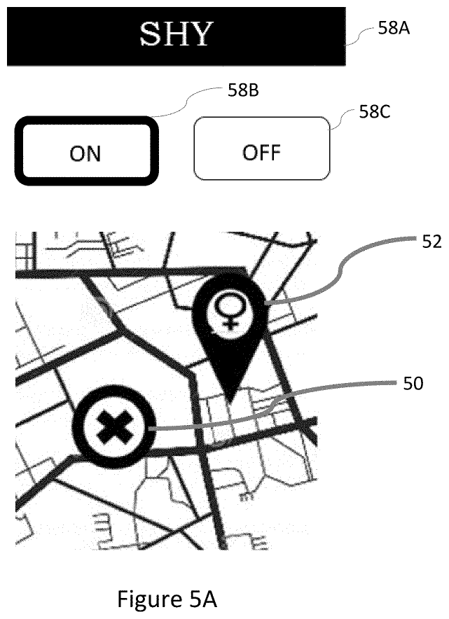

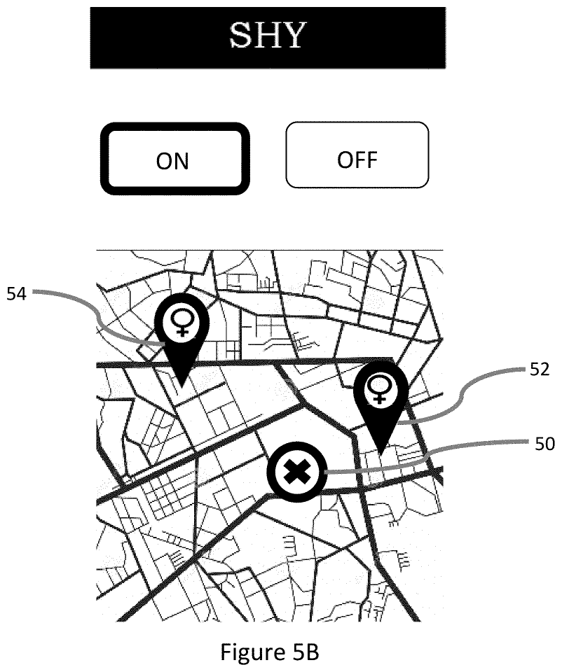

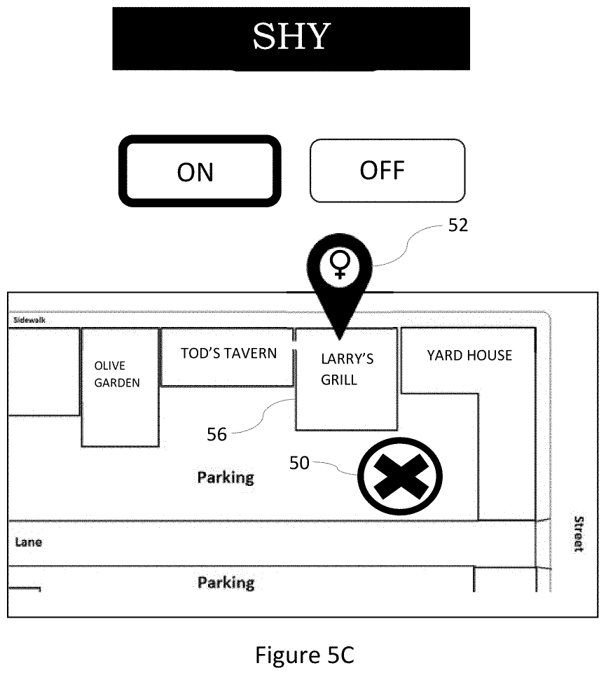

As shown in FIG. 5A, the user may then be presented with a map of their surroundings, showing their location 50 and the location of at least one other individual 52. In a preferred embodiment, and as discussed above, individual 52 is selected from criteria (e.g., sexual preference, age range, etc.) (e.g., as selected by the user, the system, etc.), so that only individuals that may be of interest to the user 50 are presented. In alternate embodiments, other individuals are also presented, allowing the user to see all (or a greater portion of) individuals that (a) have accounts with the system and (b) are within a predetermined distance from the user. The pre-determined distance may be a default distance or a user-defined distance. For example, the map may show individuals that are within one square mile around the user's location, a 100-foot radius from the user's location, within the same building as the user, etc. Obviously, other distances are within the spirit and scope of the present invention.

In FIG. 5A, the user is viewing a map provided by the SHY™ 58A application—an application configured to carry out features of the present invention. As discussed in greater detail below, the present invention requires users to share location information with at least the host device. This information can then be shared with other users unless the user disables, or turns off, their discoverability. In FIG. 5A, discoverability is turned ON 58B, e.g., by default. If the user chooses to operate in a stealth mode, the user can turn discoverability OFF 58C. This feature, along with other related discoverability features, will be discussed in greater detail below.

In a preferred embodiment, if the user moves (i.e., their location changes), then the map should move with them (e.g., keeping them at the center of the map). The user should also be able to alter the map (e.g., by dragging, pinching, or spreading their fingers, using navigation icons, a keyboard, mouse, etc.) to move in a particular direction (e.g., east, west, north, south), zoom in or zoom out. For example, as shown in FIG. 5B, the user 50 may zoom out to see other individuals 54 (i.e., creating a new user-defined distance). By way of another example, the user 50 may zoom in (e.g., to get more specific location information on an individual) (i.e., individual 52 is located inside Larry's Grill 56).

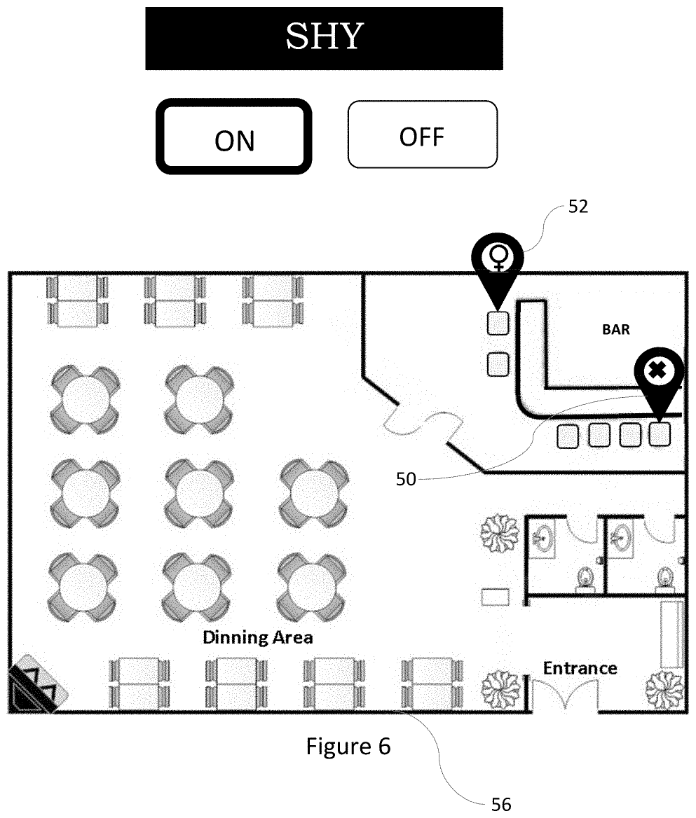

If the user 50 continues to zoom in, or interacts with (e.g., clicks on) a business, the user 50 may be presented with information concerning individuals inside the business. For example, if the user clicks on Larry's Grill 56, the user 50 may be presented with a map of the inside (see FIG. 6) and information concerning the location of individual 52 (e.g., with respect to user 50). For example, as shown in FIG. 6, the user 50 may learn that individual 52 is sitting at the other end of the bar. Alternatively, the user 50 may see individual 52 at the bar and open the application to see if individual 52 has an account or is a member. If they are, the user 50 can then use the application to learn more about and communicate with individual 52.

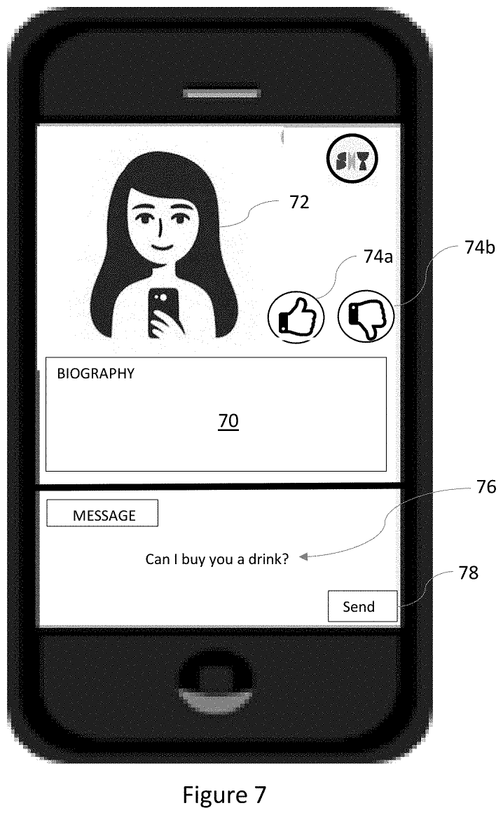

For example, by clicking on individual 52 within map 56, the user 50 may be presented with the individual's profile, including, for example, their autobiography 70 (e.g., interests, etc.) and at least one image 72 of the individual (e.g., allowing them to confirm that they have the correct profile, seeing them in other situations, etc.) (see FIG. 7). The user may also be allowed to send a communication to the individual. This communication may be a predefined communication, e.g., “thumbs up” 74a if interested, “thumbs down” 74b if not interested, etc., or it may be a personal communication entered by the user. For example, the user may enter (e.g., by typing, using voice recognition software, etc.) “Can I buy you a drink?” 76. Interacting with the “Send” button would then send the communication to the individual.

It should be appreciated that the present invention is not limited to the exemplary screen shot shown in FIG. 7, and screens having more, less, and/or different features are within the spirit and scope of the present invention. For example, additional information on the individual (e.g., their income, sexual preference, age, etc.) may be presented to the user. By way of another example, if the user has previously communicated with the individual, those previous communications may be presented to the user. By way of yet another example, the buttons on the application may provide alternate (or additional) functions. For example, the “thumbs up” 74a, “thumbs down” 74b buttons may merely affect the app (as seen by the user) and not provide a communication to the individual. By way of example, “thumbs up” 74a may store the individual as a “favorite,” “thumbs down” 74b may prevent the user from showing up on the map (or future maps) presented to the user 50, etc.

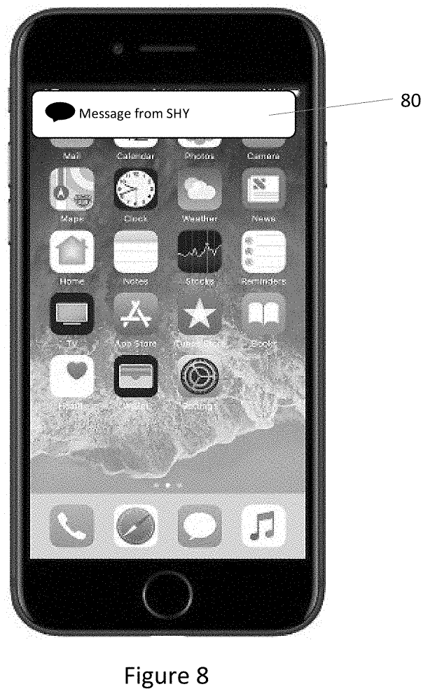

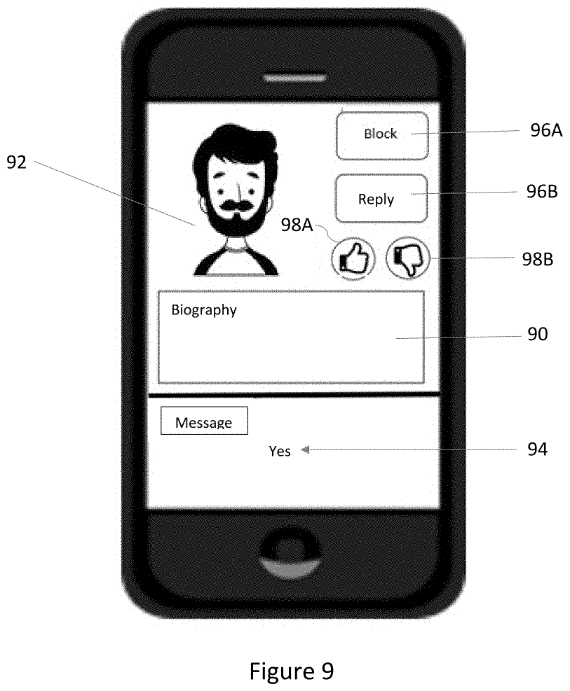

If the user sends a communication, the individual would then be notified. As shown in FIG. 3, the communication would preferably be provided to the individual's device 30 via the host device 10. By way of example, as shown in FIG. 8, the individual (i.e., via their user device) may receive a push notification 80, indicating that they have received a message (e.g., a message from the SHY™ app.). If the individual interacts with the notification, the application may open, and the individual may be presented with the message (not shown) and the user's profile, including biographical information 90 and at least one image 92 of the individual (see FIG. 9). If the individual is not interested, the individual can ignore the message (e.g., click on “thumbs down” 98b), express interest (e.g., click on “thumbs up” 98a), block them 96a (e.g., which would block additional communications and may prevent them from being shown on a map presented to the individual 52), or reply 96b. As with FIG. 7, the present invention is not limited to the exemplary screen shot shown in FIG. 9, and screens having more, less, and/or different features are within the spirit and scope of the present invention.

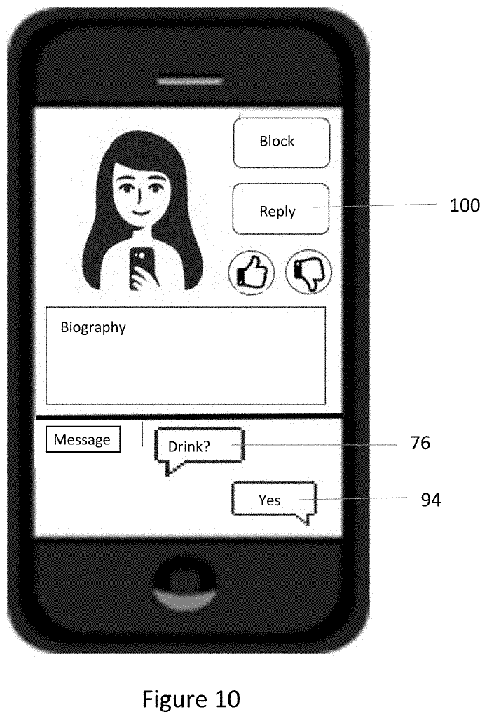

If the individual decides to reply 96b, the individual may be presented with a text box and a send button (not shown), allowing them to enter a reply. As shown in FIG. 10, the user may then see the back-and-forth communication—message 76, reply 94—and decide how to proceed. The user may reply 100, or decide to approach the individual (e.g., and buy them that drink). As can be seen, the present invention has provided a forum for individuals to meet, vet each other, and see if there is interest. If there is, the individuals can meet immediately (given the proximity). If there is not, the user can move on without having to deal with an uncomfortable rejection (e.g., in front of others), embarrassment, etc.

Clearly, in order for the present invention to function properly, location information of each user device (e.g., 20, 30) must be shared with the host device (e.g., 10). This location information can be acquire using one (or a combination of) known techniques, including, but not limited to use of global positioning satellites (“GPS”), assisted GPS, synthetic GPS, cellular towers (e.g., triangulation, signal strength, etc.), WiFi (e.g., triangulation, signal strength), Bluetooth beacons, etc. For example, GPS may be used to determine which business the user went into, whereas WiFi may be used to determine where inside the business the user is located (e.g., seated).

The present invention also needs location information on cities, streets, businesses, etc. This may be accomplished by using an application program interface (“API”) for a map product (or platform), such as Google Maps™. Such products not only provide detailed maps, but location information on individual businesses. This would allow the system to know when a user is in front (or inside) of a business. It would also provide the system with boundary, perimeter, or “footprint” information for businesses, allowing the system to differentiate between a small liquor store and a large department store. The system could then use this information, along with location information from the user's device, to determine where inside a business a user is located, even if detailed information concerning the inside of the business is not known.

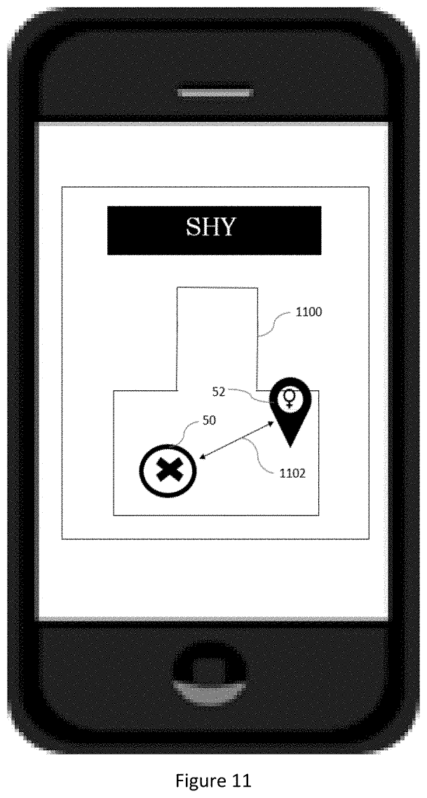

For example, as shown in FIG. 11, a map may be provided to the user that has the outline of a business 1100, and locations of the user 50 and the individual 52 within the business. This proximity 1102 may be presented via a map (see FIG. 11) and/or via textual information (e.g., Rosy is ten feet away, northeast direction, within a ten foot radius, etc.). If the system is unable to acquire location information within the business, the system may merely inform the user that the individual 52 is inside.

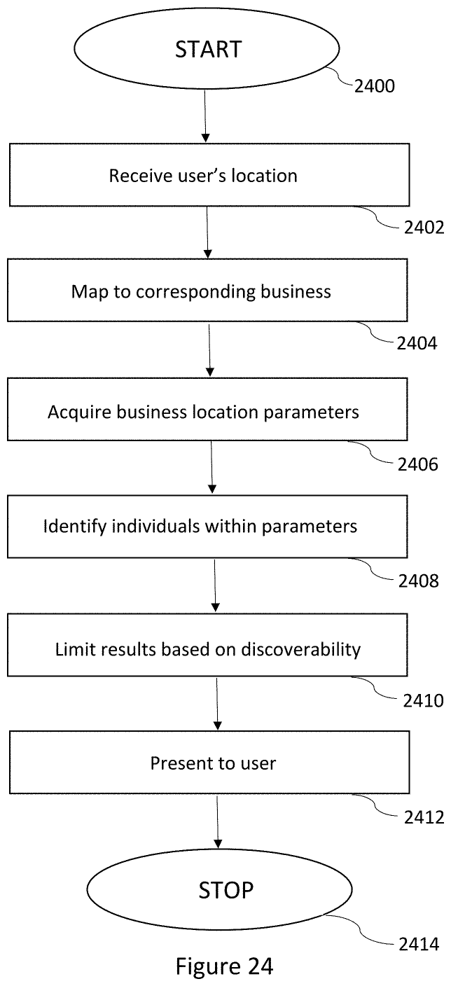

A method for carrying out the foregoing is shown in FIG. 24. Starting at 2400, the system would acquire an individual's location at step 2402. The system would them map this location to a corresponding business at step 2404. Based on information provided by the map platform (e.g., coordinates and/or address for the business, coordinates and/or addresses for adjacent businesses, map details (e.g., building outlines, etc.), etc.), location parameters (e.g., boundaries, perimeter, etc.) for the business would be acquired (or generated) at step 2406. Individuals that are located within those parameters would be identified at step 2408. These results would then be further limited (e.g., adjusted, flagged, etc.) based on discoverability limitations at step 2410. The results (as limited) would then be presented to the user (e.g., via a map, etc.) at step 2412, ending the method at step 2414. It should be appreciated that the present invention is not limited to the foregoing method, and methods including fewer, additional, and/or different steps are within the spirit and scope of the present invention.

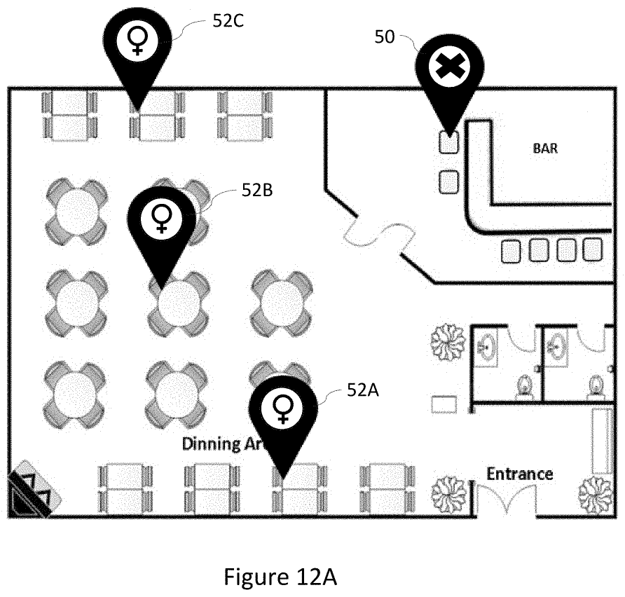

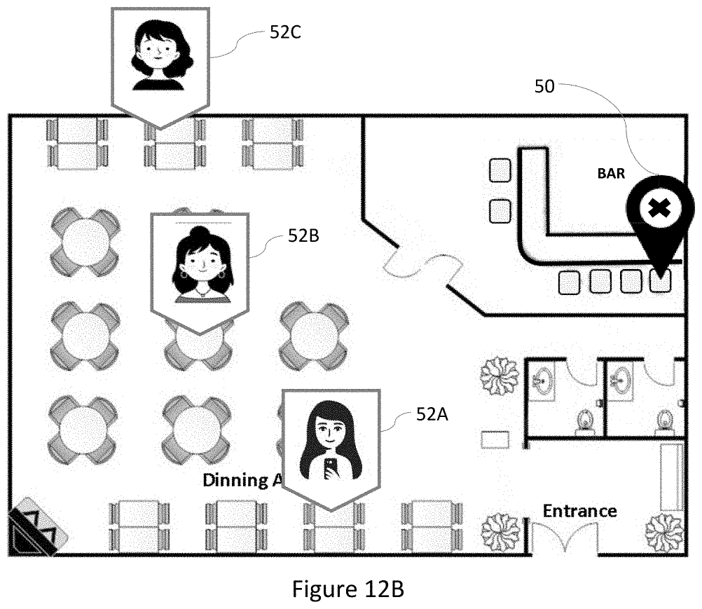

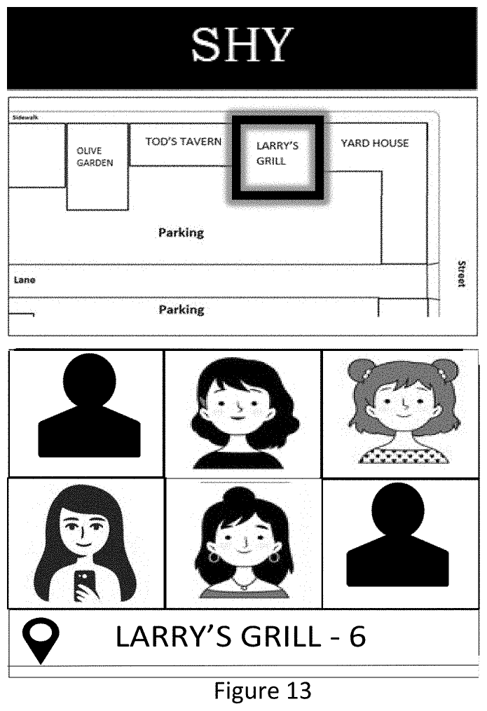

Clearly, there may be more than one individual inside a business that has an account with the system. Location information for those individuals may be provided to the user. For example, as shown in FIG. 12A, locations of different individuals (e.g., 52A, B, C) with respect to the user 50 may be provided. This may be done by providing icons for individuals (see FIG. 12A) or images for individuals (see FIG. 12B). As discussed above, if location information inside the business is not known, information on individuals that are inside the business may be provided (see, e.g., FIG. 13).

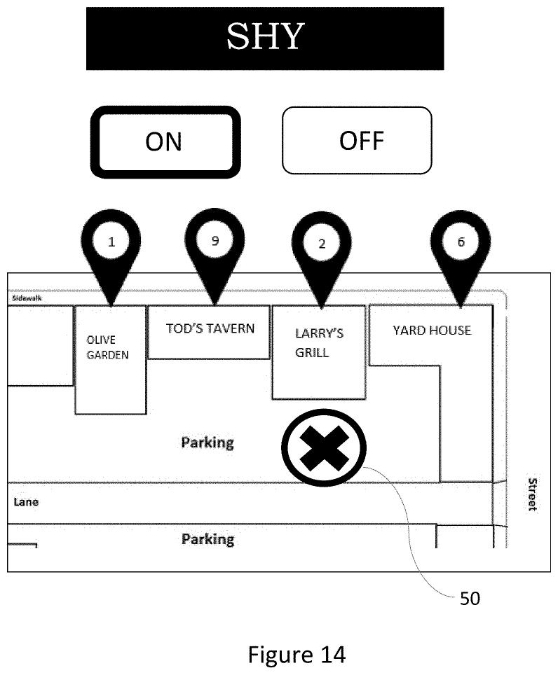

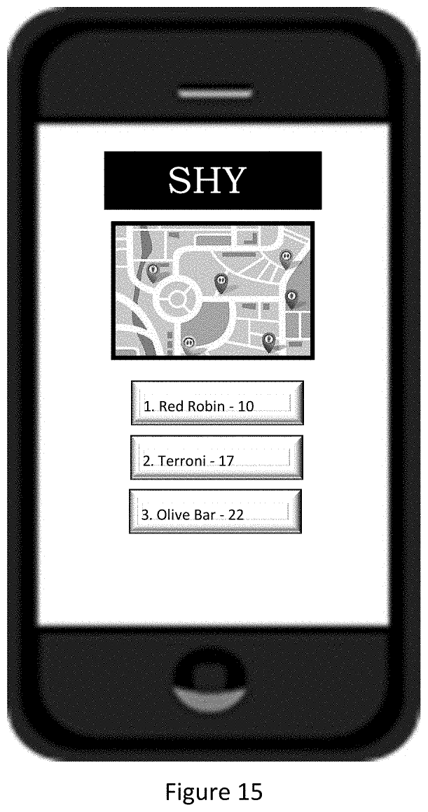

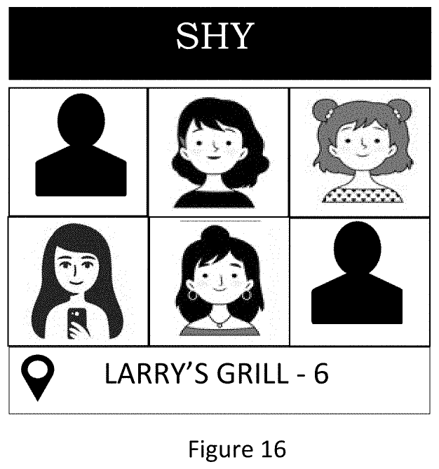

The system may also be configured to provide collective information concerning individuals that are within different establishments. For example, as shown in FIG. 14, the user 50 could see that there is one individual within Olive Garden™, two individuals inside Larry's Grill, six individuals inside the Yard House™, and nine individuals inside Tod's Tavern. Similarly, as shown in FIG. 15, there are ten individuals in Red Robin™, seventeen individuals inside Terroni™, and twenty-two individuals inside the Olive Bar. And if the user clicked on a particular business, the user may be presented with information on individual users that are within that business (see, e.g., FIG. 16). Such information could be used by the user 50 to determine where he/she should go (e.g., to experience a more lively crowd, etc.).

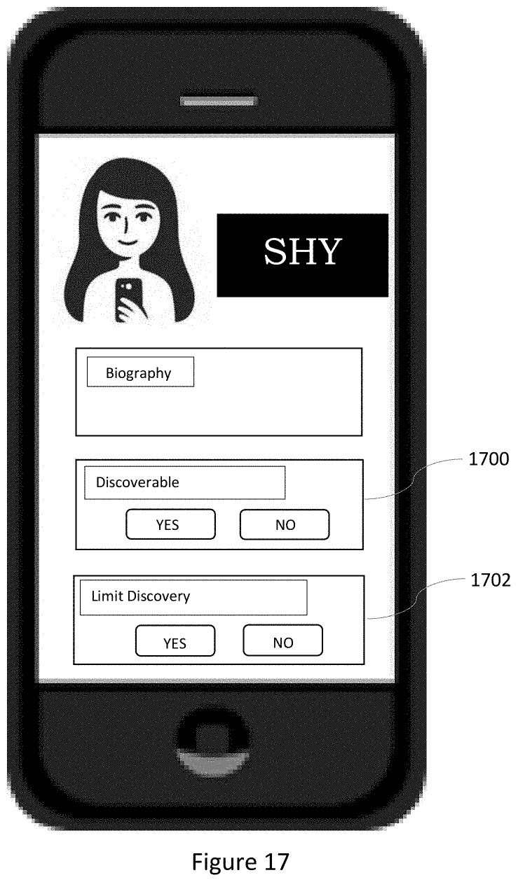

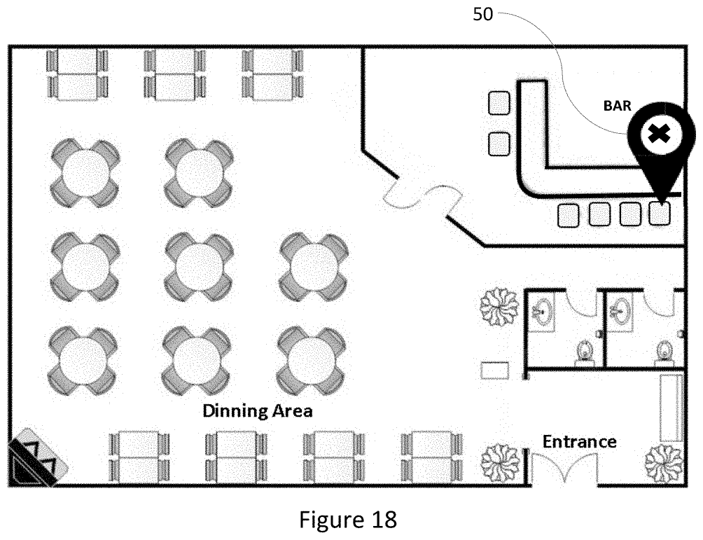

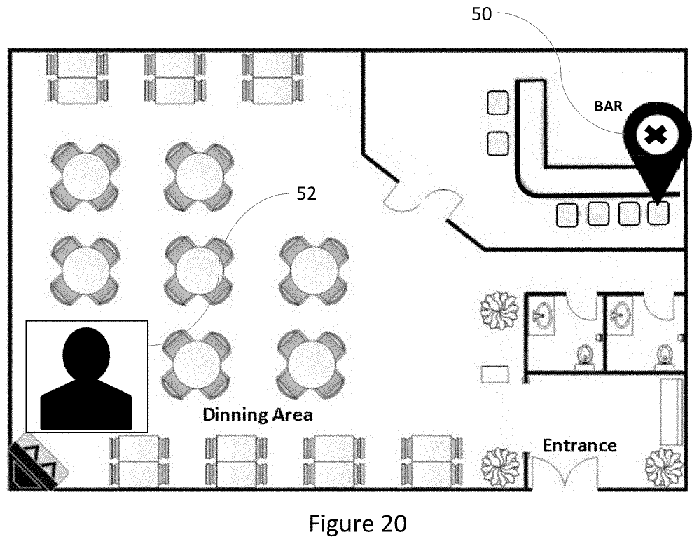

A potential problem with such a system, without safeguards, is the “creep” factor, i.e., the use of such a system to stalk, harass, or annoy a user. To address this issue, while the system preferably defaults to being “discoverable,” meaning that location information is provided to the host device and shared with other members. However, this feature should be configurable by the user. For example, as shown in FIG. 17, a user may decide to disable, or turn off, the discoverable feature 1700, which would prevent others from learning their current location. Compare, for example, FIG. 6 (showing individual 52 who is discoverable) to FIG. 18 (where individual 52 is not discoverable), where individual 52 is either shown or not shown to user 50 depending on the individual's discoverability setting. Alternatively, the user could decide to limit their discoverability (see FIG. 17 at 1702). This may result in user 50 knowing the general location of individual 52 (e.g., in a state, city, business, etc.), but not knowing their exact location. It may also prevent certain information (e.g., photos, etc.) from being shown (see, e.g., FIG. 20).

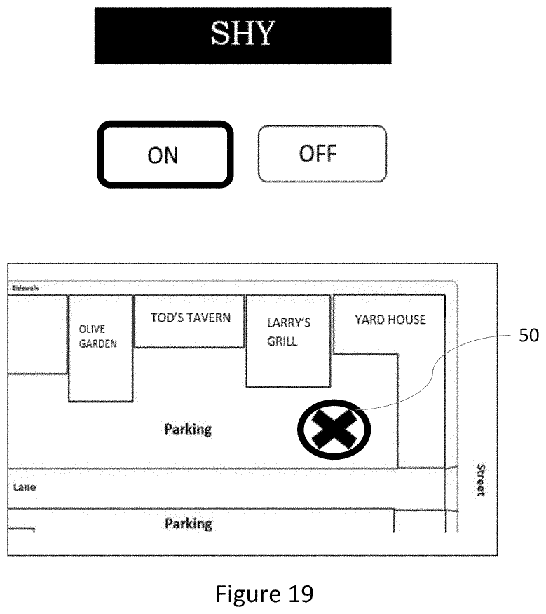

It may also limit which users have access to an individual's location. For example, if a user 50 is within a business, the user 50 may see the location of the individual 52 (see, e.g., FIG. 6). However, if the user 50 is outside the business (e.g., across the street, in a different city, etc.), the user may have no idea that individual 52 is inside Larry's Grill (see, e.g., FIG. 19) (note: the discoverability icon in FIG. 19 (ON/OFF) is for user 50, not individual 52). This can be a very powerful tool, as it prevents unwanted stalking, as the only ones that know the location of the individual are users that can actually see the individual (e.g., are sitting at the same bar, etc.), or in close proximity to the individual. This would prevent remote user's from knowing the individual's location, and still allow a user within a pre-determined distance from the individual (e.g., sitting across the bar, etc.) to view the individual's profile and communicate with them prior to any face-to-face interaction.

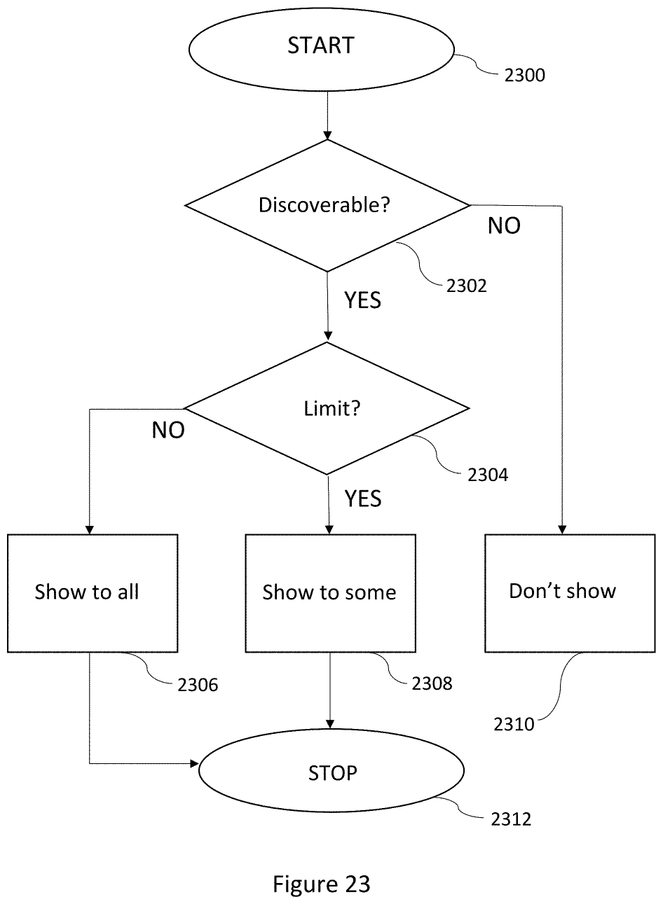

A method for carrying out the foregoing is shown in FIG. 23. Starting at 2300, the system would determine whether the user has made themselves discoverable at step 2302. In a preferred embodiment, a default setting would be that the user is discoverable. If the user changes the default setting to non-discoverable, then the system would prevent others from learning the user's current location. To incentivize a user to make themselves discoverable, the system could (but does not have to) be configured to provide reciprocity, i.e., only receive location information (e.g., on a second user) if you provide location information (e.g., to the second user). If, however, the user choses to be (or does not change the system from) discoverable, then the system would determine whether the user has limited their discoverability at step 2304. If they do not, then their location would be shown to all (or those within a first pre-determined distance from the user) at step 2306. If, however, the user choses to limit discoverability, then the user's location would be limited as discussed above at step 2308, ending the method at step 2312. This limitation may result in the user only being discoverable by those within a second pre-determined distance from the user (e.g., those within the same business, etc.).

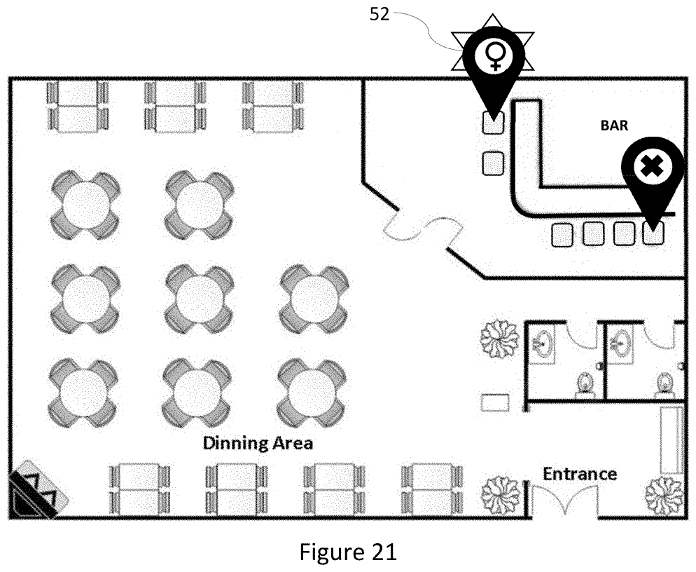

It should be appreciated that the present invention is not limited to the foregoing method, and methods including fewer, additional, and/or different steps are within the spirit and scope of the present invention. For example, if the user decides to limit their discoverability, the user may then be able to decide how that is accomplished (e.g., choosing from the limitations discussed above, etc.). It should also be appreciated that the present invention is not limited to methods where one's location is either on or off (e.g., depending on discoverability, the user's location, etc.). For example, the individual could be presented differently (see, e.g., FIG. 21) if they are a suitable match (e.g., meeting criteria selected by the user, etc.), are currently online (or logged into the app), are a favorite, have favorited the user, have previously communicated with the user, etc.

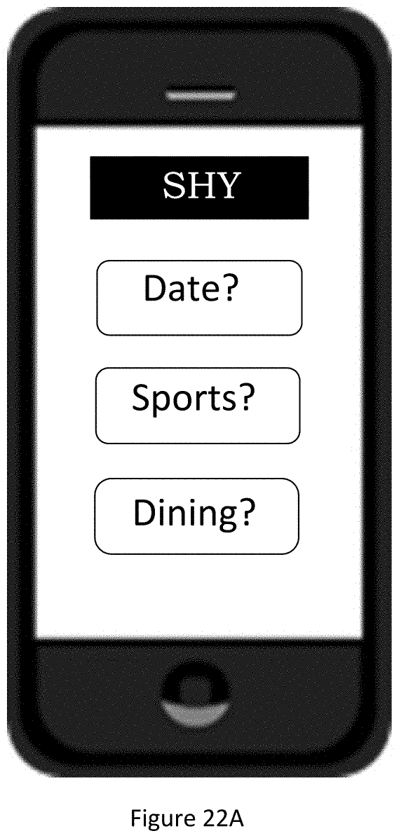

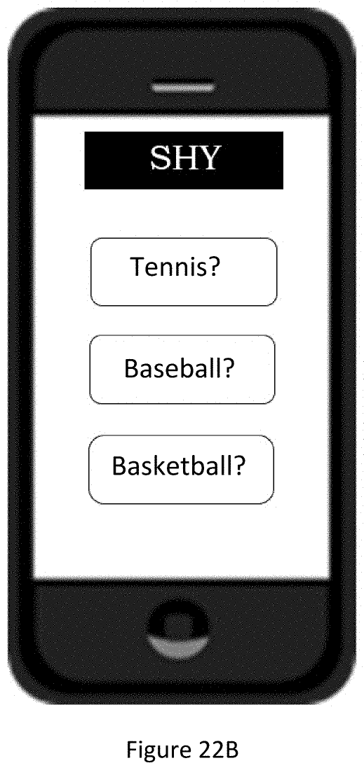

As discussed above, the present invention is not limited to dating and can be used to meet likeminded individuals. By way of example, as shown in FIG. 22A, a user could use the app to find those interested in other activities, such as sports, food, etc. For example, a user could select “sports” to find another person for “tennis,” “baseball,” “basketball,” etc. (see, e.g., FIG. 22B). It should be appreciated that the present invention is not limited to these alternatives, and other interests, such as gambling, nightclubs, exercising, rideshare, etc., are within the spirit and scope of the present invention. For example, the present invention could be used to find a fifth for a poker game, a spotter at a health club, or a ride home from the airport. Instead of traditional online interest groups, the present invention takes advantage of proximity between users, allowing likeminded individuals who are near one another to participate in an agreed upon activity. And by limiting discoverability, only those that are in close proximity (pre-defined proximity, user-defined proximity) will be presented to the user.

The foregoing description of a system and method for using a network-connected host device to facilitate a communication between at least a first user and a second user has been presented for the purposes of illustration and description. It is not intended to be exhaustive or to limit the invention to the precise forms disclosed, and many modifications and variations are possible in light of the above teachings. Those skilled in the art will appreciate that there are a number of ways to implement the foregoing features, and that the present invention it not limited to any particular way of implementing these features. The invention is solely defined by the following claims.

What is claimed is:

1. A method for using at least one host device associated with a dating website to facilitate a communication between a user and a potential companion, comprising:
receiving from a user device information concerning said user, which is used to identify a used to identify a user account on said host device, said user account having biographical information on said user including at least one picture of said user;
receiving a request from said user to identify individuals that have accounts with said host and are within a predefined distance from said user;
receiving location information from said user device and from other users having accounts with said host;
using said location information to provide a map to said user, said map showing said user and a plurality of said other users that are within said predefined distance from said user, said map further showing locations of said plurality of said other users with respect to said user;
receiving a request from said user to communicate with one of said plurality of said other users along with a message to be communicated to said one of said plurality of said other users; and
providing said message to a second user device being operated by said one of said plurality of said other users along said location of user with respect to said one of said plurality of said other users;
wherein said one of said plurality of said other users can view said biographical information on said user and respond to said message by providing a request to do so to said host device along with a second message, said second message being provided to said user device.

2. The method of claim 1, wherein said host device is further configured to receive a request from a second one of said other users to be undiscoverable, resulting in at least said second one not being shown on said map even though said second one is within said predefined distance from said use.

3. The method of claim 1, wherein said host device is further configured to receive a request from a second one of said other users to limit discoverability, resulting in said map showing said second one of said other users but not showing their location with respect to with respect to said user even though said second one is within said predefined distance from said user.

4. The method of claim 1, wherein said host device is further configured to receive a request from a second one of said other users to limit discoverability, resulting in a location of said second one only being provided to users that are within said predefined distance from said second one of said other users.

5. The method of claim 4, wherein said predefined distance is a user-defined distance.

6. The method of claim 4, wherein said predefined distance from said second one of said other users is a building that said second one of said other users is located within.

7. The method of claim 6, further comprising the steps of using said location of said second one of said other users to identify a building that said second one is located within, identify a boundary for said building, and only providing said location of said second one to users that are wherein said boundary for said building.

8. The method of claim 1, wherein said message is pushed onto said second user device.

9. The method of claim 1, wherein said message is a personalized message entered by said user.

10. The method of claim 1, wherein said message is a predefined message provided as a result of said user indicating interest in one of said plurality of said other users.

11. A system for using a dating service to facilitate a communication between a user and a potential companion, comprising:
at least one host in communication with at least one wide area network (WAN) and comprising at least one memory device for storing machine readable instructions adapted to perform the steps of:
receive from a user device information concerning said user, which is used to identify a used to identify a user account on said host device, said user account having biographical information on said user including at least one picture of said user;
receive a request from said user to identify individuals that have accounts with said host and are within a predefined distance from said user;
receive location information from said user device and from other users having accounts with said host;
use said location information to provide a map to said user, said map showing said user and a plurality of said other users that are within said predefined distance from said user, said map further showing locations of said plurality of said other users with respect to said user;
receive a request from said user to communicate with one of said plurality of said other users along with a message to be communicated to said one of said plurality of said other users; and
provide said message to a second user device being operated by said one of said plurality of said other users along said location of user with respect to said one of said plurality of said other users;
wherein said one of said plurality of said other users can view said biographical information on said user and respond to said message by providing a request to do so to said host device along with a second message, said second message being provided to said user device.

12. The system of claim 11, wherein said machine readable instructions are further adapted to receive a request from a second one of said other users to be undiscoverable, resulting in at least said second one not being shown on said map even though said second one is within said predefined distance from said use.

13. The system of claim 11, wherein said machine readable instructions are further adapted to receive a request from a second one of said other users to limit discoverability, resulting in said map showing said second one of said other users but not showing their location with respect to with respect to said user even though said second one is within said predefined distance from said user.

14. The system of claim 11, wherein said machine readable instructions are further adapted to receive a request from a second one of said other users to limit discoverability, resulting in a location of said second one only being provided to users that are within said predefined distance from said second one of said other users.

15. The system of claim 14, wherein said predefined distance from said second one of said other users is a building that said second one of said other users is located within.

16. The system of claim 15, wherein said machine readable instructions are further adapted to use said location of said second one of said other users to identify a building that said second one is located within, identify a boundary for said building, and only providing said location of said second one to users that are wherein said boundary for said building.

17. The system of claim 11, wherein said message is one of a personalized message entered by said user and a predefined message provided as a result of said user indicating interest in one of said plurality of said other users.

18. A method for using at least one host device having a plurality of users to facilitate a communication between a first user and a second user, comprising:
receiving from a first user device a location of said first user;
receiving a request from said first user that is located within a business to identify other users that are also located within said business;
retrieving locations from other users including said second user;
retrieving location information associated with said business;
identifying a portion of said other users that are located within said business, said portion including at least said second user;
providing a map to said first user showing said portion of said other users that are located within said business, said map including at least a location of said second user with respect to said first user;
receiving a request from said first user to communicate with said second user along with a message to be communicated to said second user; and
providing said message to said second user along said location of said first user with respect to said second user;
wherein said second user can view biographical information on said first user and respond to said message by providing a request to do so to said host device along with a second message, said second message being provided to said first user.

19. The method of claim 18, wherein said location information can be used to identify a boundary associated with business, which can then be used to determine whether specific locations are within or outside said boundary of said business.

20. The method of claim 18, wherein said location of said second user is only provided to said plurality of users that are located within said business, and is not provided to said plurality of users that are located outside of said business.
